(19) United States
(12) Patent Application Publication
(10) Pub. No.: US 2025/0188636 A1
(43) Pub. Date: Jun. 12, 2025

(54) METAL RECOVERY AGENT, METAL RECOVERY MEMBER, METAL RECOVERY LIQUID AGENT AND METAL RECOVERY METHOD

(71) Applicant: IHI Corporation, Tokyo (JP)

(72) Inventor: Yasuyuki FUKUSHIMA, Tokyo (JP)

(73) Assignee: IHI Corporation, Tokyo (JP)

(21) Appl. No.: 19/055,009

(22) Filed: Feb. 17, 2025

Related U.S. Application Data
(63) Continuation of application No. PCT/JP2023/031232, filed on Aug. 29, 2023.

(30) Foreign Application Priority Data
Sep. 6, 2022 (JP) 2022-141343

(51) Int. Cl. C25C 1/20; C25C 7/06; C25D 3/48

(52) U.S. Cl. CPC C25C 1/20; C25C 7/06; C25D 3/48

(57) ABSTRACT

A metal recovery agent includes a reducing compound represented by chemical formula (1), and metal is deposited by reduction with the reducing compound. In chemical formula (1), R1 is CH₃ or CHO, R2 is CH═CH₂ or CHO, R3 is CH₃ or CHO, R4 is CH₂CH₃ or CH═CH₂, R5 is COOCH₃ or H, R6 is a hydrocarbon group or H, and M is metal or hydrogen.

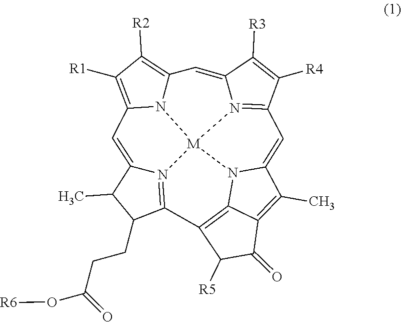

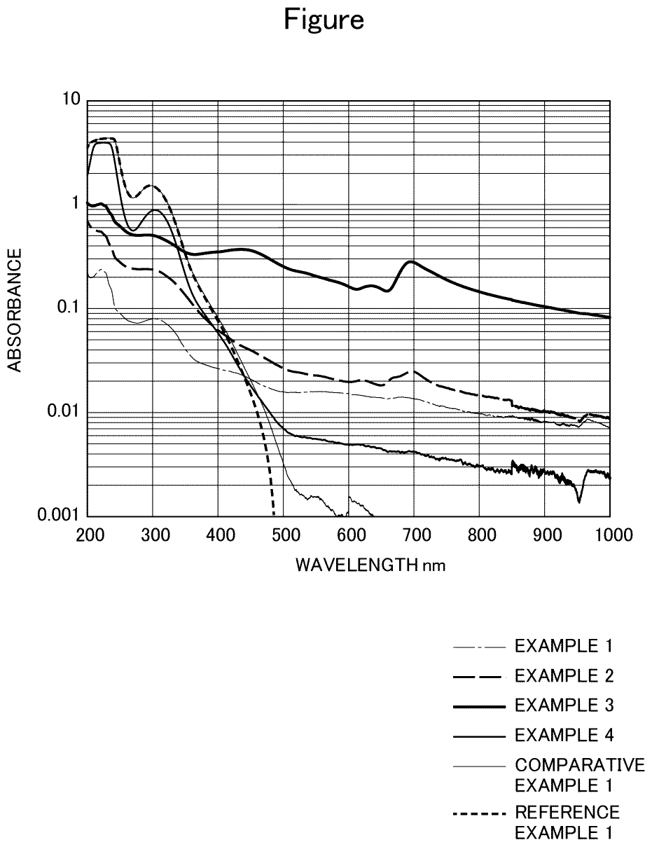

### CROSS-REFERENCE TO RELATED APPLICATIONS

This application is a continuation application of International Application No. PCT/JP2023/031232, filed on Aug. 29, 2023, which claims priority to Japanese Patent Application No. 2022-141343, filed on Sep. 6, 2022, the entire contents of which are incorporated by reference herein.

### BACKGROUND

### 1. Technical Field

The present disclosure relates to a metal recovery agent, a metal recovery member, a metal recovery liquid agent, and a metal recovery method.

### 2. Description of the Related Art

Conventional methods are known for recovering a small amount of metal dissolved in a solution by means of a biological method. Specifically, WO 2018/155687 discloses a method for recovering metal using algae.

The metal recovery agent or metal compound recovery agent in WO 2018/155687 contains a dried product of a cell of a red alga in the order Cyanidium, a cell-derived dried product of a red alga in the order Cyanidium, a dried product of a cell, or an artificial product simulating a cell-derived dried product. According to WO 2018/155687, the metal recovery agent and the metal recovery method can selectively recover noble metal from a solution with high acid concentration, or the like, in an easy and efficient manner.

### SUMMARY

Organisms such as algae have complex reaction pathways to which various molecules contribute. However, it is not easy to artificially control such multiple reactions. Therefore, it may be difficult to reduce and recover metal under a controlled environment by a biological method using algae or the like.

Therefore, it is an object of the present disclosure to provide a metal recovery agent, a metal recovery member, a metal recovery liquid agent, and a metal recovery method capable of recovering metal under an artificially controlled environment.

A metal recovery agent according to the present disclosure includes a reducing compound represented by chemical formula (1), and metal is deposited by reduction with the reducing compound.

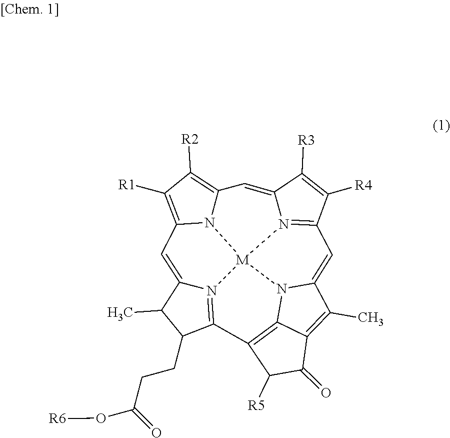

In the chemical formula (1), R1 is CH₃ or CHO, R2 is CH═CH₂ or CHO, R3 is CH₃ or CHO, R4 is CH₂CH₃ or CH═CH₂, R5 is COOCH₃ or H, R6 is a hydrocarbon group or H, and M is metal or hydrogen.

The reducing compound may be at least one compound selected from a group consisting of chlorophyll a, pheophorbide a, pyropheophorbide a, and pheophytin a.

The standard electrode potential of the metal deposited by reduction with the reducing compound may be greater than or equal to the standard electrode potential of aluminum.

The metal deposited by reduction with the reducing compound may contain at least one element selected from a group consisting of gold, silver, copper, tin, cobalt, iron, silicon, nickel, platinum, palladium, rhodium, iridium, ruthenium, osmium, strontium, manganese, cesium, scandium, yttrium, and the lanthanoids.

The metal deposited by reduction with the reducing compound may contain gold.

A metal recovery member according to the present disclosure includes a metal recovery agent, and a carrier for carrying the metal recovery agent.

A metal recovery liquid agent according to the present disclosure includes a liquid, and a metal recovery agent dispersed or dissolved in the liquid.

A metal recovery method according to the present disclosure includes a step of reducing and depositing metal dissolved in a metal solution with a reducing compound represented by chemical formula (1).

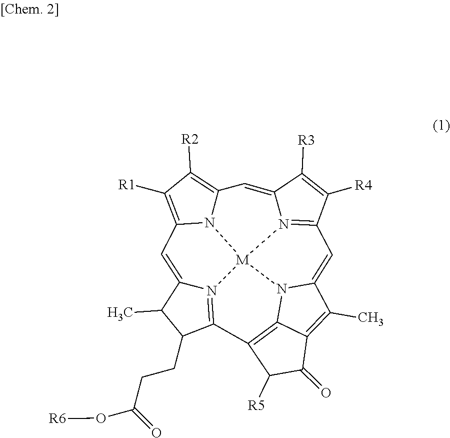

In the chemical formula (1), R1 is CH₃ or CHO, R2 is CH═CH₂ or CHO, R3 is CH₃ or CHO, R4 is CH₂CH₃ or CH═CH₂, R5 is COOCH₃ or H, R6 is a hydrocarbon group or H, and M is metal or hydrogen.

In the step of reducing metal, the reducing compound may be irradiated with light.

### Advantageous Effects of Invention

According to the present disclosure, it is possible to provide a metal recovery agent, a metal recovery member, a metal recovery liquid agent and a metal recovery method capable of recovering metal under an artificially controlled environment.

### BRIEF DESCRIPTION OF THE DRAWINGS

The FIGURE illustrates absorption spectra of test solutions according to examples, a comparative example, and a reference example.

### DESCRIPTION OF THE EMBODIMENTS

Several exemplary embodiments will be described below with reference to the drawings. Note that the dimensional ratio in the drawings is exaggerated for convenience of explanation, and may differ from the actual ratio.

### [Metal Recovery Agent]

First, a metal recovery agent according to the present embodiment will be described. The metal recovery agent according to the present embodiment deposits metal by reduction with a reducing compound. Therefore, the metal recovery agent can also be referred to as a reducing agent. Specifically, the metal recovery agent includes a reducing compound represented by chemical formula (1) below. The reducing compound according to the present embodiment has a chlorin structure. A reducing compound may be used alone, or a plurality of reducing compounds may be mixed to be used. The reducing compound does not form a complex with a substance such as a protein, and may be a single reducing compound or a mixture of reducing compounds.

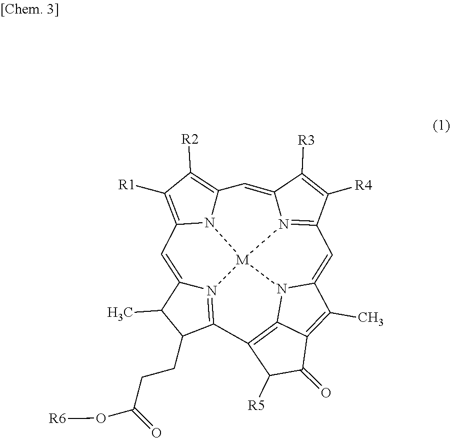

In chemical formula (1) above, R1 is CH₃ or CHO, R2 is CH═CH₂ or CHO, R3 is CH₃ or CHO, R4 is CH₂CH₃ or CH═CH₂, R5 is COOCH₃ or H, R6 is a hydrocarbon group or H, and M is metal or hydrogen. That is, R1 may be CH₃ or CHO. R2 may be CH═CH₂ or CHO. R3 may be CH₃ or CHO. R4 may be CH₂CH₃ or CH═CH₂. R5 may be COOCH₃ or H. R6 may be a hydrocarbon group or H. M may be a metal or hydrogen.

In chemical formula (1) above, the hydrocarbon group of R6 may be an alkyl group, an alkenyl group, an alkynyl group or an aryl group. The carbon number of the hydrocarbon group of R6 may be greater than or equal to 1 and less than or equal to 100, greater than or equal to 1 and less than or equal to 50, greater than or equal to 1 and less than or equal to 30, or greater than or equal to 1 and less than or equal to 20. Specifically, the hydrocarbon group of R6 may be a phytyl group (—C₂₀H₃₉). In chemical formula (1) above, the metal represented by M may be, for example, Mg.

The reducing compound may be at least one compound selected from the group consisting of chlorophyll a, pheophorbide a, pyropheophorbide a, and pheophytin a. Chlorophyll a is a kind of pigment used for photosynthesis, and is contained in organisms such as plants, algae, and cyanobacteria. Chlorophyll a and derivatives of chlorophyll, such as pheophorbide a, pyropheophorbide a, and pheophytin a, are abundant on the earth, and can be synthesized by such organisms. Therefore, metals can be recovered with low environmental load by using these reducing compounds. In addition, since metals are deposited by the reducing compounds, there is no need to use special microorganisms, and there is no need to consider the conditions for subculture of such microorganisms or to fear their extinction. In addition, since these compounds can be extracted from general-purpose organisms that are easy to culture, the cost required for metal recovery can be reduced.

Chlorophyll a is a compound represented by chemical formula (2) below. That is, chlorophyll a is a compound represented by chemical formula (1) above, in which R1 is CH₃, R2 is CH═CH₂, R3 is CH₃, R4 is CH₂CH₃, R5 is COOCH₃, R6 is a phytyl group, and M is Mg.

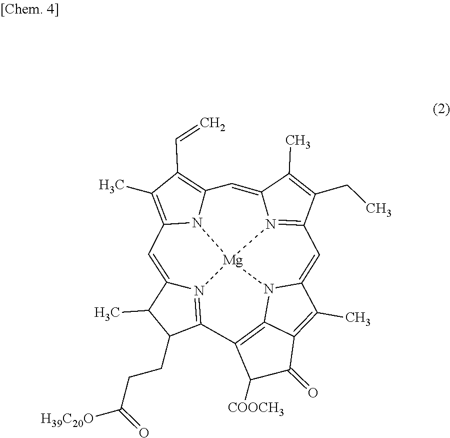

Pheophorbide a is a compound represented by chemical formula (3) below. Specifically, pheophorbide a is a compound represented by chemical formula (1) in which R1 is CH₃, R2 is CH═CH₂, R3 is CH₃, R4 is CH₂CH₃, R5 is COOCH₃, R6 is H, and M is two hydrogen atoms. Pheophorbide a is a compound in which the phytyl group of chlorophyll a is replaced with a hydrogen atom, and magnesium is replaced with two hydrogen atoms.

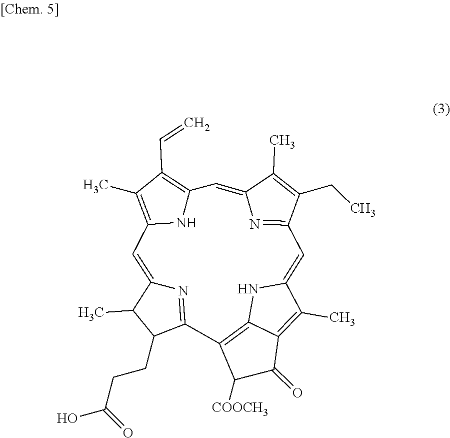 [SMILES: C=Cc1c(C)c2cc3nc(c4c5[nH]c(cc6nc(cc1[nH]2)C(C)=C6CC)c(C)c5C(=O)C4C(=O)OC)C(CCC(=O)O)C3C]

Pyropheophorbide a is a compound represented by chemical formula (4) below. That is, pyropheophorbide a is a compound represented by chemical formula (1) above, in which R1 is CH₃, R2 is CH═CH₂, R3 is CH₃, R4 is CH₂CH₃, R5 is H, R6 is H, and M is two hydrogen atoms. Specifically, pyropheophorbide a is a compound in which the methoxycarbonyl group (—COOCH₃) of pheophorbide a is replaced with a hydrogen atom. That is, pyropheophorbide a is a compound in which the methoxycarbonyl group (—COOCH₃) of chlorophyll a is replaced with a hydrogen atom, the phytyl group of chlorophyll a is replaced with a hydrogen atom, and magnesium is replaced with two hydrogen atoms.

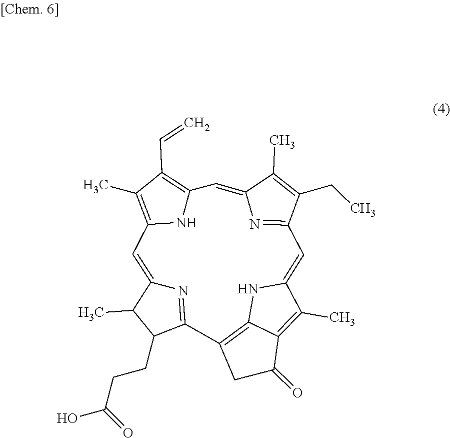 [SMILES: C=Cc1c(C)c2cc3nc(c4c5[nH]c(cc6nc(cc1[nH]2)C(C)=C6CC)c(C)c5C(=O)C4)C(CCC(=O)O)C3C]

Pheophytin a is a compound represented by the following chemical formula (5). Specifically, pheophytin a is represented by chemical formula (1) above, in which R1 is CH₃, R2 is CH═CH₂, R3 is CH₃, R4 is CH₂CH₃, R5 is COOCH₃, R6 is a phytyl group, and M is two hydrogen atoms. Specifically, pheophytin a is a compound in which magnesium of chlorophyll a is replaced with two hydrogen atoms.

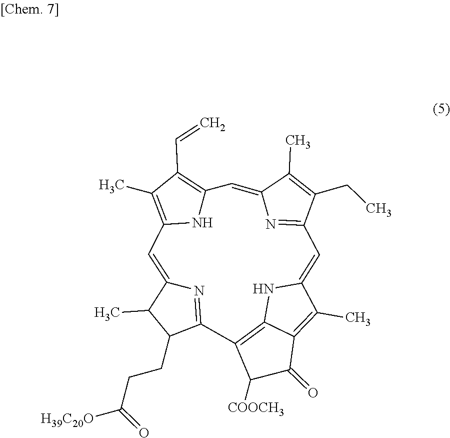

Chlorophyll a, pheophorbide a, pyropheophorbide a, and pheophytin a are described as examples of the reducing compounds, but the reducing compounds may be other compounds. Examples of the reducing compounds may include chlorophyll b, chlorophyll d, chlorophyll f, and derivatives thereof. Chlorophyll derivatives include pheophorbide, pyropheophorbide, and pheophytin.

Chlorophyll b is represented by chemical formula (1) above, in which R1 is CH₃, R2 is CH═CH₂, R3 is CHO, R4 is CH₂CH₃, R5 is COOCH₃, R6 is a phytyl group, and M is Mg.

Chlorophyll d is represented by chemical formula (1) above, in which R1 is CH₃, R2 is CHO, R3 is CH₃, R4 is CH₂CH₃, R5 is COOCH₃, R6 is a phytyl group, and M is Mg.

Chlorophyll f is represented by chemical formula (1) above, in which R1 is CHO, R2 is CH═CH₂, R3 is CH₃, R4 is CH₂CH₃, R5 is COOCH₃, R6 is a phytyl group, and M is Mg.

Examples of the metal recovery agent may include a powder containing a plurality of particles containing a reducing compound, a bound body of a plurality of particles containing a reducing compound, or a combination thereof. The shape of particles of reducing compounds is not particularly limited, and may be at least one shape selected from a group consisting of a needle-like, angular, dendritic, fibrous, fragmented, irregular, tear-drop and spherical shape. The shape of a bound body is not particularly limited, and may be sheet-like, rod-like, prismatic, spherical, cylindrical, irregular shape or a combination thereof.

The metal recovery agent deposits metal by reduction with a reducing compound. Specifically, metal is recovered from a solution in which the metal is dissolved. The solution in which metal is dissolved contains ions containing the metal. Metal in the solution can be recovered by donating electrons to ions containing the metal, and reducing and depositing the metal. The ions containing the metal may be cations, such as Ag⁺, in which electrons are emitted from a single metal element, or complex ions such as tetrachloroaurate (III) ion ([AuCl₄]⁻), dicyanoaurate (I) ion ([Au (CN) ₂]⁻), and Au (HS) ²⁻.

The standard electrode potential of the metal deposited by reduction with a reducing compound may be greater than or equal to the standard electrode potential of aluminum. Such metal is easily deposited by reduction with a reducing compound. Therefore, the metal deposited by reduction with the reducing compound may include aluminum, and may include metal having the standard electrode potential greater than aluminum.

Specifically, the metal deposited by reduction may include at least one metal selected from a group consisting of gold, silver, copper, tin, cobalt, iron, silicon, nickel, platinum, palladium, rhodium, iridium, ruthenium, osmium, strontium, manganese, cesium, scandium, yttrium, and the lanthanoids. These metals are industrially useful. Examples of the lanthanoids include lanthanum, cerium, praseodymium, neodymium, promethium, samarium, europium, gadolinium, terbium, dysprosium, holmium, erbium, thulium, ytterbium, and lutetium. The metal may include gold. Gold is also used as an ornament, and is highly valuable because of its scarcity.

The metal deposited by reduction may be crystalline or amorphous. The average particle size of the metal deposited by reduction may be 0.1 nm or larger, or 10 nm or larger. The average particle diameter of the metal deposited by reduction may be 1 nm or more. The average particle diameter of the metal deposited by reduction may be 10 mm or less, 1 mm or less, 100 m or less, 10 m or less, 1 m or less, or 100 nm or less. The metal may be reduced at an atomic level, and then undergo surface migration to grow crystals. The average particle diameter is a value calculated as the average particle diameter of particles observed in several to several tens of fields of view using an observation means such as a scanning electron microscope (SEM) or a transmission electron microscope (TEM).

The metal recovery agent may contain 50 mass % or more, 60 mass % or more, 70 mass % or more, 80 mass % or more, 90 mass % or more, 95 mass % or more, or 99 mass % or more of a reducing compound.

As described above, the metal recovery agent according to the present embodiment includes a reducing compound represented by chemical formula (1) above, and deposits metal by reduction with a reducing compound. Therefore, the metal recovery agent according to the present embodiment can recover metal under an artificially controlled environment.

### [Metal Recovery Member]

Next, a metal recovery member according to the present embodiment will be described. The metal recovery member according to the present embodiment includes a metal recovery agent, and a carrier for carrying the metal recovery agent, as described above. In the metal recovery member according to the present embodiment, the metal recovery agent is carried on the carrier, so that the metal recovery agent can be easily handled. For example, metal in a metal solution can be easily recovered by bringing the metal recovery member into contact with the metal solution in which the metal is dissolved.

The shape of the carrier is not particularly limited as long as it can carry the metal recovery agent. The carrier may be fibrous, for example. The material of the carrier is not particularly limited, but may include, for example, at least one material selected from a group consisting of cellulose, glass, plastic, carbon, metal, ceramics, and wood. Examples of the metal recovery member may include a sheet containing a fibrous carrier on which the metal recovery agent is carried.

### [Metal Recovery Liquid Agent]

Next, a metal recovery liquid agent according to the present embodiment will be described. The metal recovery liquid agent according to the present embodiment includes a liquid, and the metal recovery agent described above dispersed or dissolved in the liquid. In the metal recovery liquid agent according to the present embodiment, the metal recovery agent is dispersed or dissolved in the liquid, so that the metal recovery agent can be easily handled. For example, the metal in the metal solution can be easily recovered by mixing the metal recovery liquid agent with the metal solution in which the metal is dissolved.

The liquid in which the metal recovery agent is dispersed or dissolved may be an organic compound, an inorganic compound, or a liquid mixture thereof. The organic compound may be an alcohol, a ketone, a halomethane, or a liquid mixture thereof. The inorganic compound may be water. Examples of the alcohol may include at least one selected from a group consisting of methanol, ethanol, 1-propanol, 2-propanol, 1-butanol, 2-methyl-1-propanol, 2-butanol and 1-methyl-2-propanol. Examples of ketone may include at least one of acetone and methyl ethyl ketone. Examples of halomethane may include dichloromethane.

The metal recovery agent may be dispersed in a liquid, dissolved in a liquid, or dispersed and dissolved in a liquid. The content of the metal recovery agent in the metal recovery liquid agent is not particularly limited, and can be prepared, as appropriate.

### [Metal Recovery Method]

Next, a metal recovery method according to the present embodiment will be described. The metal recovery method according to the present embodiment includes a step of reducing and depositing metal dissolved in a metal solution with a reducing compound represented by chemical formula (1) above. Therefore, with the metal recovery method according to the present embodiment, the metal can be recovered under an artificially controlled environment, as described above.

The metal solution in which metal is dissolved contains ions containing the metal. For example, when a metal solution is brought into contact with a reducing compound by adding or immersing the reducing compound to the metal solution, electrons are donated to the ions containing the metal, thereby reducing the metal. The metal in the solution can be recovered by deposition of the reduced metal.

The metal solution is not particularly limited, and examples thereof include waste water from electronic industries, such as plating waste liquid, seawater, solutions of a metal element-containing substance, or the like. Specifically, the solution of the metal element-containing substance may be a solution obtained by dissolving a part or all of at least one of metal and a metal compound contained in the metal element-containing substance. The metal element-containing substance is not particularly limited as long as it contains one or more of metal elements, more specifically, metals or metal compounds. Examples of the metal element-containing substance may include an electronic substrate in a waste electronic apparatus, known as an urban mine. Since the metal contained in the metal solution is the same as the metal deposited by reduction as described above, the description thereof is omitted.

The concentration of the metal in the metal solution is not particularly limited, and may be 10⁻⁶ ppm or more, and 10⁵ ppm or less. By setting the concentration of the metal in the range above, the recovery of the metal can be promoted. The concentration of the metal may be 10⁻⁵ ppm or more, 10⁻⁴ ppm or more, 10⁻³ ppm or more, 0.01 ppm or more, 0.1 ppm or more, 1 ppm or more, or 10 ppm or more. The concentration of the metal may be 10,000 ppm or less, 5,000 ppm or less, 2,500 ppm or less, 1,000 ppm or less, 500 ppm or less, 250 ppm or less, or 125 ppm or less. In this specification, ppm means parts per million by mass.

The pH of the metal solution is not particularly limited, and may be, for example, −3 or more, and 8 or less. The pH of the metal solution may be −2 or more, −1 or more, 0 or more, 1 or more, 2 or more, 3 or more, 4 or more, 5 or more, or 6 or more. The pH of the metal solution may be 7 or less.

The ratio of the mass of the reducing compound to the mass of the metal in the metal solution (hereinafter also referred to as a reducing compound/metal ratio) is not particularly limited, and may be, for example, 0.1 to 10,000. By setting the reducing compound/metal ratio in this range, recovery of the metal can be promoted. The reducing compound/metal ratio may be 0.5 or more, 1 or more, 1.5 or more, or 2 or more. The reducing compound/metal ratio may be 1,000 or less, 500 or less, 100 or less, 50 or less, 10 or less, or 5 or less.

The amount of a reducing compound to a metal solution is not particularly limited. From the viewpoint of promoting reduction reaction of metal, a reducing compound may be brought into contact with a metal solution so that the amount of the reducing compound to the metal solution is 0.2 mg/100 mL or more, and 1,000 mg/100 mL or less. The amount of the reducing compound to the metal solution may be 2, 10, 20 or 40 mg/100 mL or more. The amount of the reducing compound to the metal solution may be 500, 400, 200 or 100 mg/100 mL or less.

The temperature at which the metal is reduced is not particularly limited, and may be, for example, 0° C. or higher, and 100° C. or lower. The temperature may be 10° C. or higher, or 20° C. or higher. The temperature may be 70° C. or lower, 50° C. or lower, 40° C. or lower, or 30° C. or lower.

The time for reducing metal may be, for example, 5 minutes or more, 30 minutes or more, 1 hour or more, 8 hours or more, 1 day or more, 3 days or more, 4 days or more, or 5 days or more from the viewpoint of sufficiently promoting the reduction reaction. The time for reducing the metal may be, for example, 20 days or less, 10 days or less, 8 days or less, or 6 days or less.

In the step of reducing metal, a reducing compound may be irradiated with light. By irradiating a reducing compound with light, the reduction reaction of the metal by the reducing compound can be promoted. In this case, the light irradiated to the reducing compound may include visible light. The light irradiated to the reducing compound may have a light component at a wavelength of 300 nm or more, and 700 nm or less. The light source of the light irradiated to the reducing compound may include at least one of natural light and a light irradiation device. The natural light may include sunlight. The light irradiation device may include at least one light source selected from a group consisting of an LED (Light Emitting Diode), a fluorescent lamp, and an incandescent lamp. In the step of reducing metal, the metal may be reduced while shielding the reducing compound from light.

A photon flux density of light irradiated to a reducing compound may be 10 μmol·m⁻² s⁻¹ or more. By making the photon flux density greater than or equal to the value above, the reduction reaction of metal by the reducing compound can be further promoted. In this specification, photon flux density means the number of photons per unit time and per unit area contained in a wavelength of 300 nm to 700 nm.

Preferably, the metal solution is stirred while reducing the metal. The number of revolutions in stirring is not particularly limited, and may be, for example, 100 rpm to 1000 rpm.

The metal deposited from the metal solution may be separated by membrane separation such as filtration, and centrifugation. The metal deposited may be adsorbed on the reducing compound, separated from the reducing compound to form a colloidal solution, or a combination thereof. If the metal deposited adheres to the reducing compound, the metal deposited may be recovered by recovering the reducing compound. If the metal deposited separates from the reducing compound, the metal deposited may be recovered by removing the reducing compound from the metal solution.

An ultrasonic treatment may be performed to remove the metal deposited from the reducing compound. The ultrasonic treatment may be performed before separating the reducing compound from the metal solution, or it may be performed after separating the reducing compound from the metal solution and immersing the separated reducing compound in a liquid. When ultrasonic treatment is performed after immersing the separated reducing compound in the liquid, a metal colloidal solution of higher purity can be obtained.

The step of recovering metal may further include a step of firing a recovered reducing compound in order to recover the metal from the recovered reducing compound. Through this step, the reducing compound itself is removed, and the metal adsorbed on the reducing compound can be recovered. The firing can be easily performed, for example, in air. The firing temperature is not particularly limited, and can be suitably selected in accordance with the melting point of the metal. The firing temperature may be, for example, 800° C. to 1200° C. The firing temperature may be constant or increased stepwise. For example, a reducing compound may first be heated at a combustion temperature of the reducing compound for a certain period of time, and then heating may be continued at a temperature near the melting point of the metal in order to improve crystallinity of the metal.

After the recovered reducing compound is molded, the molded reducing compound may be fired to form a metal molded product. In molding of the reducing compound, for example, the recovered reducing compound may be molded into a desired shape, such as a star shape or a heart shape. The method of molding a reducing compound is not particularly limited, and for example, a recovered reducing compound may be pressed into a mold having a desired shape. The molded recovery agent may be fired under the conditions described above. The metal molding may be for an ornament. That is, a produced metal molding may be used as an ornament such as a necklace or an earring.

### EXAMPLES

Hereinafter, the present embodiment will be described in more detail with reference to examples, a comparative example and a reference example. However, the present embodiment is not limited to these examples.

### Example 1

Water and hydrogen tetrachloroaurate (III) tetrahydrate (HAuCl₄·4H₂O), manufactured by FUJIFILM Wako Pure Chemical Corporation, were mixed in a 300 mL beaker so that the gold concentration became 100 ppm by mass (Au content of 10 mg) to prepare a 100 mL HAuCl₄ aqueous solution. To this HAuCl₄ aqueous solution, 50 mg of chlorophyll a (manufactured by FUJIFILM Wako Pure Chemical Corporation, product number 034-21361) (CAS registration number: 479-61-8) was added to obtain a prepared solution having a pH of about 5.

Under room temperature (about 25° C.), an illumination lamp was turned on so that the photon flux density became about 100 μmol·m⁻²·s⁻⁴, and a prepared solution obtained as described above was stirred for 5 days with the stirrer rotated at 300 rpm. The stirred solution was filtered to collect the test solution.

### Example 2

A test solution was collected following the same procedure as in Example 1 except that pheophorbide a (manufactured by Cayman Chemical, product number 16072) (CAS registration number: 15664-29-6) was used instead of chlorophyll a.

### Example 3

A test solution was collected following the same procedure as in Example 1 except that pyropheophorbide a (manufactured by Cayman Chemical, product number 21371) (CAS registration number: 24533-72-0) was used instead of chlorophyll a.

### Example 4

A test solution was collected following the same procedure as in Example 1 except that pheophytin a (manufactured by FUJIFILM Wako Pure Chemical Corporation, product number 167-13771) (CAS registration number: 603-17-8) was used instead of chlorophyll a.

### Comparative Example 1

A test solution was collected following the same procedure as in Example 1 except that chlorophyll a was not added.

### Reference Example 1

An aqueous solution of HAuCl₄ prepared in Example 1 before addition of chlorophyll a was used as a test solution.

### [Evaluation]

The test solutions obtained as described above were measured by ultraviolet/visible spectroscopy. Spectra obtained by ultraviolet/visible spectroscopy are illustrated in the FIGURE. As illustrated in the FIGURE, a peak at a wavelength of around 310 nm characteristic of HAuCl₄ was smaller in Examples 1 to 4 than in Comparative Example 1 and Reference Example 1. From these results, it is understood that gold in the HAuCl₄ aqueous solution was reduced and deposited in Examples 1 to 4. On the other hand, the spectra of Comparative Example 1 and Reference Example 1 significantly overlapped, and it was difficult to distinguish them. From this result, it can be seen that not much gold in the HAuCl₄ aqueous solution was reduced in Comparative Example 1.

Next, a gold recovery rate was calculated from a measurement result by the ultraviolet/visible spectroscopy. The gold recovery rate was calculated by formula (1) below:

Gold recovery rate (%)={1−(Absorbance of a peak at a wavelength of around 310 nm in Example and Comparative Example/Absorbance of a peak at a wavelength of around 310 nm in Reference Example 1)}×100 (1)

TABLE 1

| | | | Gold |
|---|---|---|---|
| | | | Recovery Rate |
| | Reducing Compound | Stirring | (%) |
| Example 1 | Chlorophyll a | 5 days | 93 |
| Example 2 | Pheop horbide a | 5 days | 79 |
| Example 3 | Pyropheophorbide a | 5 days | 56 |
| Example 4 | Pheophytin a | 5 days | 24 |
| Comparative | — | 5 days | 0 |
| Example 1 | | | |
| Reference | — | 0 days | 0 |
| Example 1 | | | |

As shown in Table 1, the gold recovery rate when chlorophyll a of Example 1 was used was 93%. The gold recovery rate when pheophorbide a of Example 2 was used was 79%. The gold recovery rate when pyropheophorbide a of Example 3 was 56%. The gold recovery rate when pheophytin a of Example 4 was used was 24%. On the other hand, the gold recovery rate when a reducing compound was not used, as in Comparative Example 1, was 0%. From these results, it can be seen that the metal can be recovered by using a metal recovery agent having a reducing compound represented by the chemical formula (1).

The entire contents of Japanese Patent Application No. 2022-141343 (filing date: Sep. 6, 2022) are incorporated herein by reference.

Several embodiments have been described. However, modifications or variations of the embodiments may be made based on the disclosure above. All the components of the embodiments described above and all the features described in the claims may be individually extracted and combined as long as they do not contradict each other.

The present disclosure can contribute, for example, to Goal 9 “Build resilient infrastructure, promote inclusive and sustainable industrialization, and foster innovation”, and Goal 12 “Ensure sustainable consumption and production patterns” of the United Nations-led Sustainable Development Goals (SDGs).

What is claimed is:

1. A metal recovery agent comprising a reducing compound represented by formula (1), wherein metal is deposited by reduction with the reducing compound, 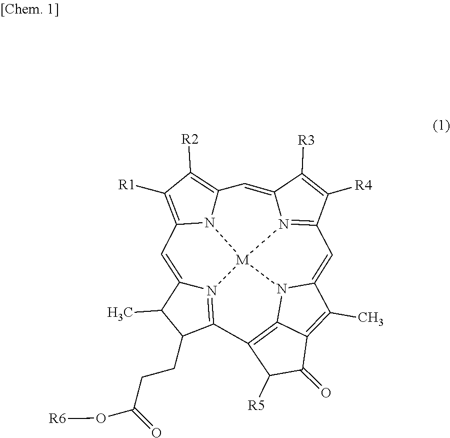
where R1 is CH₃ or CHO, R2 is CH═CH₂ or CHO, R3 is CH₃ or CHO, R4 is CH₂CH₃ or CH═CH₂, R5 is COOCH₃ or H, R6 is a hydrocarbon group or H, and M is metal or hydrogen.

2. The metal recovery agent according to claim 1, wherein the reducing compound is at least one compound selected from a group consisting of chlorophyll a, pheophorbide a, pyropheophorbide a, and pheophytin a.

3. The metal recovery agent according to claim 1, wherein the standard electrode potential of the metal deposited by reduction with the reducing compound is greater than or equal to the standard electrode potential of aluminum.

4. The metal recovery agent according to claim 1, wherein the metal deposited by reduction with the reducing compound contains at least one element selected from a group consisting of gold, silver, copper, tin, cobalt, iron, silicon, nickel, platinum, palladium, rhodium, iridium, ruthenium, osmium, strontium, manganese, cesium, scandium, yttrium, and lanthanoids.

5. The metal recovery agent according to claim 1, wherein the metal deposited by reduction with the reducing compound contains gold.

6. A metal recovery member comprising:
the metal recovery agent according to claim 1; and
a carrier for carrying the metal recovery agent.

7. A metal recovery liquid agent comprising:
a liquid, and
the metal recovery agent according to claim 1, which is dispersed or dissolved in the liquid.

8. A metal recovery method comprising a step of reducing and depositing metal dissolved in a metal solution with a reducing compound represented by chemical formula (1), 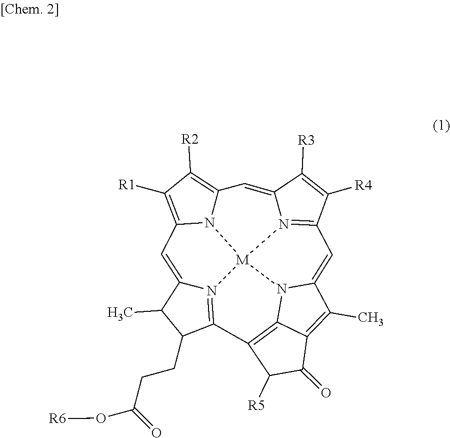
where R1 is CH₃ or CHO, R2 is CH═CH₂ or CHO, R3 is CH₃ or CHO, R4 is CH₂CH₃ or CH═CH₂, R5 is COOCH₃ or H, R6 is a hydrocarbon group or H, and M is metal or hydrogen.

9. The metal recovery method according to claim 8, wherein in the step of reducing metal, the reducing compound is irradiated with light.
